(19) United States
(12) Patent Application Publication
(10) Pub. No.: US 2007/0289648 A1
(43) Pub. Date: Dec. 20, 2007

(54) TAP

(75) Inventor: Alfons Knapp, Biberach (DE)

Correspondence Address: BRINKS HOFER GILSON & LIONE, P.O. BOX 10395, CHICAGO, IL, 60610, US

(73) Assignee: Masco Corporation of Indiana, Indianapolis, IN (US)

(21) Appl. No.: 11/835,799

(22) Filed: Aug. 8, 2007

Related U.S. Application Data
(63) Continuation of application No. PCT/EP2006/000849, filed on Dec. 15, 2005.

(30) Foreign Application Priority Data
Feb. 8, 2005 (IT) TO2005A000068

(51) Int. Cl. F16K 11/078

(52) U.S. Cl. 137/625.4

(57) ABSTRACT

Provided is a tap (9) having a base (10) for fixed installation and a body (20) that can be mounted on the fixed base (10) and removed from said base. According to the disclosure, the removable body (20) has an essentially bell-or-well-shaped form, having a larger opening (8) on the side that is to be connected to the fixed base (10) and a smaller opening (21) on the opposite side (7). The interior of the tap (9) is equipped with mechanisms (40-43), which can be introduced into the removable body (20) via the larger opening (8) and can be removed from said body (20) via this opening (8).

### CROSS-REFERENCE TO RELATED APPLICATIONS

This application is a continuation of International Application No. PCT/EP2006/000849 filed on Feb. 1, 2006, which claims the benefit of Italy Patent Application No. T02005A000068, filed Feb. 8, 2005. The disclosures of the above applications are incorporated herein by reference.

### FIELD

The present disclosure relates to improvements to a faucet, in particular, to one that is intended for, but not limited to, permanent installation.

### BACKGROUND

The statements in this section merely provide background information related to the present disclosure and may not constitute prior art.

Faucets are known that comprise a base for permanent mounting or installation on a hydraulic device or on a wall, and which comprise a detachably mountable body on the fixed base. These faucets have the advantage that the body can detached from the base for repair, maintenance, or for the replacement of parts or the replacement of the entire faucet, without having to detach the base from the inflow and outflow pipes. This makes the corresponding operation relatively simple.

However, the known faucets also have disadvantages: The body of these faucets is closed on the part opposite the base by a ring that serves as a cap. This design is also known from faucets that are not provided with a fixed base. Many maintenance operations, for example cleaning, checking or replacing a cartridge or parts of the mechanism inside the faucet, require that the ring be demounted in order to remove parts from the body. This operation in turn requires the use of special tools that are not always available. Dismantling can also be relatively difficult and delicate and lead to strain on the body of the faucet, damaging the mounting and changing the position of the body.

The presence of the ring that serves as a cap can result in difficulties and production costs, because this is an additional component that must be manufactured, provided with a thread, chrome-plated and/or polished. The body must also be provided with a thread in order to accept the ring. In addition, the presence of the ring reduces freedom when designing the faucet and results in larger dimensions. In addition, there is a rise in the cost of finishing.

An additional problem with the known faucets results from the fact that the base and the body of the faucet are hydraulically connected by means of tubular butts, which are provided in one of the parts, and which are supposed to interact in a hydraulically tight manner when the seats of the other part. This kind of assembly allows for only extremely small dimensional tolerances and therefore requires exact and precise manufacturing, which in turn can have an unfavorable influence on the manufacturing cost of the faucet and the effort required to mount it.

DE 44 37 371 A1 describes a faucet with a cartridge that is mounted on a fixed base. A detachable body can then be placed over the cartridge. EP 0 210 666 A1 discloses a faucet with a cartridge that is placed on the fixed base. Then a mounting ring is screwed onto the fixed base, and the cartridge is braced between the base and the body. DE 41 38 938 A1 shows a faucet that has a casing that is mounted on a fixed base. Then the water connection elements, along with a cartridge, are inserted into the ring from above and screwed to the base. U.S. Pat. No. 1,056,743 describes a faucet with a housing that can be screwed to a base.

### SUMMARY

The present disclosure provides a faucet of the type cited at the beginning, in which the disadvantages of known faucets are eliminated or reduced.

This is achieved by means of a faucet with the characteristics of claim 1. Advantageous further embodiments are shown in the subordinate claims. Important characteristics of the disclosure are also found in the following description and in the drawings. It should also be noted that these characteristics may be provided in completely different combinations, in accordance with the teachings of the present disclosure, without this being explicitly pointed out.

In the case of the inventive faucet (preferably all) mechanisms present inside the faucet can be inserted into and removed from the bell, or as the case may be pot-shaped body via the larger opening. For mounting, only the body has to be mounted on the base. Alternatively, the mechanisms can be mounted on the base, and the body is then simply “placed over” the mechanisms. This simplifies both the production and mounting of the faucet. It also simplifies demounting for maintenance, and subsequent remounting is made simpler. In addition, design latitude is improved.

From a design view, the bell-shaped body can be made of one part or of two or more parts, which, for example, might comprise a tubular part and a partial end-closing ring.

The mechanisms on the interior of the faucet can advantageously be fabricated in the form of a cartridge, which can be inserted into or removed from the bell-shaped body in one piece through the larger opening.

In this way, it is sufficient to demount the body from the fixed base after the actuation devices of the faucet has been removed, in order to obtain access to the internal mechanisms and to remove them for any kind of work to be performed on them. This makes the entire process much simpler, particularly when the mechanisms are configured in the form of a cartridge. Reassembly of the faucet is correspondingly simplified. These steps can easily be performed by the user, even without professional training.

The base of the faucet is advantageously made of metal and has connections for the pipes, and the body of the faucet is made of injection-molded plastic material or machined metal. This results in both improved properties of the parts of the faucet and lower production costs.

Advantageously, the mechanisms inside the faucet collectively comprise positioning means relative to the base and/or positioning means relative to the body. The positioning means relative to the body that are present on the mechanisms can advantageously have several selective, discrete working positions.

In this way, correct adjustment of the body relative to the base can be achieved indirectly and changed as well, without it being necessary for these parts to comprise direct positioning means. However, if this should become necessary, the adjustment of the body relative to the base can also be achieved in a variable manner, so that completely different requirements for installation can be met. If the body does not comprise any positioning means, the correct position thereof can be selected by adjusting it in a suitable manner at the time of assembly.

According to one aspect of the disclosure, hydraulic tightness between the fixed base and the entirety of the mechanisms on the inside of the body can be achieved by means of frontal, or as the case may be face effective sealing means.

The frontal, or as the case may be face effective sealing means comprises a sleeve that is inserted into a hollow seat provided in the base or in the mechanisms of the faucet.

Due to the frontal (axial) effect of the sealing means, considerable positional tolerances are possible during assembly, and the tolerances for machining parts can therefore be higher. This enables economical machining, and the positioning of the detachable body relative to the fixed base is not critical, which simplifies assembly.

In one embodiment, the totality of the mechanisms inside the faucet comprises a base disk, which interacts directly with the sealing means that are effective frontally or on the face between the base and the mechanism.

In another embodiment, the entire mechanism of the faucet comprises a fixed closing plate that is formed, for example, by a frontal wall of the housing, which interacts directly with the frontal, or as the case may be face sealing means that operate between the base and the mechanism.

In one embodiment, the detachable body is fastened to the fixed base by means of at least two screws, which extend through the body in the longitudinal direction of the same. This embodiment is particularly suitable in instances where the fixed base has to be affixed to a wall.

In another embodiment, the fixed base features a ring-shaped part with an annular surface in the shape of a truncated cone, and at least two setscrews are screwed into a lateral wall of the detachable body and countervail, in an operating position, the truncated cone-shaped annular surface of the base, by means of which the body is anchored. This embodiment is particularly suitable in cases where the fixed base must be affixed to a hydraulic device.

In both of the cited embodiments, the means for attaching the body to the base can be handled with normal tools and exert a force that presses the body toward the base, which assures efficient functioning of the frontal, or as the case may be axially effective sealing means.

In one particular embodiment, the bell, or as the case may be pot-shaped body forms the support for an external cylindrical, or as the case may be, tube-shaped body, which is rotatably mounted on the bell, or as the case may be pot-shaped body and holds an outlet in place.

The external, rotatable body is preferably held in place by a ring that serves as a cap and is placed on the bell or pot-shaped body.

In this way, a faucet is created in a suitable manner with an adjustable outlet. Demounting of the external rotatable body and the outlet can be achieved by demounting only the adjusting lever and the cup while replacing the cartridge, without requiring demounting of the external, rotatable body.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

In order that the invention may be well understood, there will now be described an embodiment thereof, given by way of example, reference being made to the accompanying drawing, in which:

The invention is explained in detail below with reference to the attached drawing. It shows:

FIG. 1 is an axial sectional view of a first embodiment of a faucet, for which a base can be affixed to a wall;

FIG. 2 is an axial sectional view of a second embodiment of a faucet, for which a base can be mounted on a hydraulic device;

FIG. 3 is a detail III of FIG. 2;

FIG. 4 is the faucet according to FIG. 2, after a body is detached from the base;

FIG. 5 is the faucet according to FIG. 2 after the internal mechanisms have been removed from the body; and

FIG. 6 is an axial sectional view of a third embodiment of a faucet, comprising a rotatable body with an adjustable outlet.

### DETAILED DESCRIPTION

The following description is merely exemplary in nature and is not intended to limit the present disclosure, application, or uses.

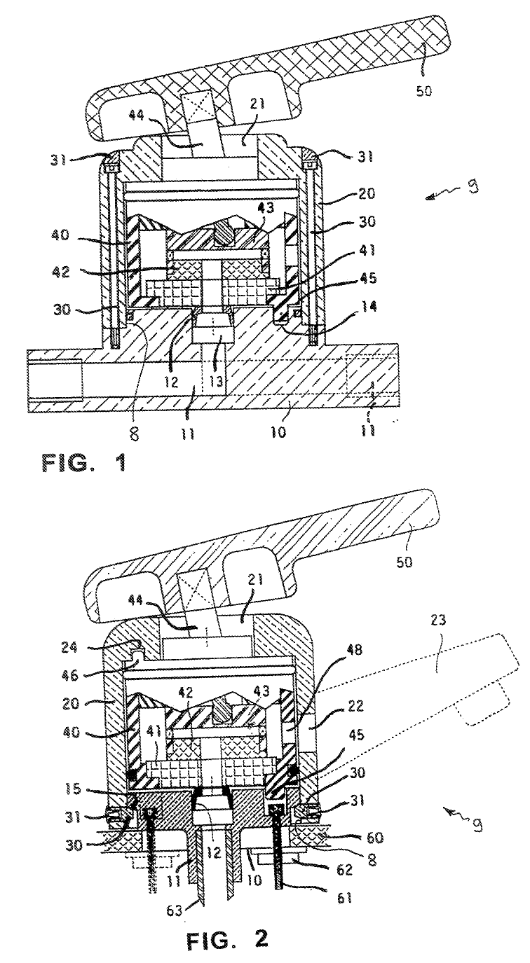

In FIG. 1, a faucet as a whole carries the reference numeral 9. It comprises a base 10 for permanent installation in or on a wall and a body 20 for detachable mounting on the base 10. This type of faucet will normally be used for controlling the water flow in bathtubs, showers, and similar applications in recessed or built-in form.

The body 20 has the shape of a bell or a inversed pot, with a larger opening 8 on the side facing the base 10. All or at least a considerable part of the mechanisms 40-43 of the faucet 9 are accommodated in the body 20, meaning those valves and hydraulic parts that act on the water flow. Further reference will be made to this below.

In all figures, the different hydraulic ducts present in the base and in the mechanisms of the faucet, at least some of which are actually eccentric, are depicted by means of a single central duct, for reasons of simplicity and clarity.

These mechanisms 40-43 can be inserted into the body 20 via the larger opening 8 of the body 20 and removed from it via this opening when the body is detached from the base 10. In the embodiment shown in FIG. 1, the body 20 is fastened to the base 10 by means of a pair of screws 30, which pass through the body 20 in the longitudinal direction thereof and are screwed into threaded holes in the base 10. Plugs 31 may be provided to cover, protect and visually conceal the heads of the screws 30.

The body 20 can be made of one piece, as shown, or it can comprise a plurality of parts that are connected to each other.

The base 10 has supply and discharge pipes 11. The hydraulic tightness between these pipes and the mechanisms 40-43 in the body 20 is produced by frontal, or as the case may be face sealing means, which in the present example are made of elastic sleeves 12 that are placed in corresponding seats 13 provided in the base 10.

In the embodiment shown in FIG. 1, the mechanisms provided in the body 20 comprise a cartridge. This, in turn, has a fixed base disk 41, a movable control disk 42, a slide 43 for actuating the moveable control disk 42, and a control lever 44. The latter protrudes from a smaller opening 21, which is provided on the side 7 of the body 20 that is opposite from the larger opening 8. Affixed to the control lever 44 is an adjusting lever 50, which can be actuated by a user. The sleeve 12 is disposed axially on the fixed base disk 41 and radially in the seat 13 formed in the base 10 by stepped boring.

It should be noted at this point that the mechanisms of the faucet may also be configured completely differently.

It is apparent that it is sufficient to unscrew the screws 30 in order to detach the body 20 from the base 10 (after the adjusting lever 50 has been removed from the control lever 44). Then, once the adjusting lever 50 has been removed, the cartridge 40 can be removed from the body 20 through the larger opening 8, provided on the side of the body 20 that is connected with the base 10. The cartridge can be tested, cleaned, repaired, or replaced, and can then be reinserted into the body 20. The body 20 can then be reaffixed to the base 10 by means of the screws 30, and the adjusting lever 50 can be reaffixed to the control lever 44.

It is obvious that this entire process can be carried out easily and quickly by an expert user, for example a plumber, but also by a relatively inexperienced user, for example, a do-it-yourself person, without any difficulty and by using simple tools, for example a screwdriver. It is also apparent that another body 20 with different mechanisms can be mounted to the base 10, provided that the base is adapted for this kind of mounting.

Even when a minor positioning error occurs during the mounting of the body 20 on the base 10, or when parts have greater fabrication tolerances, this does not creates any disadvantages in view of the large tolerances ensured by the frontal, or as the case may be, axial sealing means 12.

The correct orientation of the totality of the mechanisms 40-43 of the faucet 9 relative to the base 10 is secured by the positioning means, for example a projection 45 that is configured on the cartridge and engages a corresponding seat, or as the case may be a corresponding recess 14, in the base 10. In principle, also a reverse design is possible.

In the embodiment depicted, the cartridge 40 has no housing face wall, and the fixed base disk 41 interacts directly with the sealing sleeve 12. This makes it possible to simplify the structure of the cartridge 40 and reduce the number of sealing means required. In an embodiment not shown here, a cartridge 40 is used that has a housing face wall in the form of a closing plate. The sealing sleeve 12 can also be replaced by another kind of sealing means, for example by an O-ring or a profiled gasket. In addition, the sealing means can also be mounted in the mechanisms of the faucet 9 in the base. The mechanisms of the faucet 9 can also be joined on the inside of the body 20 without forming a cartridge.

A ring that serves as a cap is not present in the faucet 9 shown in FIG. 1. As a result, the dimensions of the body 20, and thus the internal dimensions of the faucet 9, are relatively small. The body 20 of the faucet 9 takes on an extremely simple form, which, on the one hand enables economical fabrication, for example from injection-molded plastic material or machined metal, and on the other hand, may have any arbitrarily selected external shape that is chosen on aesthetic grounds, or as the case may be for design reasons. It should be stressed that, if desired for special, for example aesthetic reasons, or in order to simplify fabrication, the body 20, for example, in the form of a bell, or as the case may be a pot, can also accommodate a ring or a cap, which does not need to be demounted, however, in order to obtain access to the mechanisms 40-43 inside the body 20.

An alternative embodiment will now be described with reference to FIG. 2. In so doing, in this instance and below, elements and areas with equivalent or similar functions as previously described elements and areas will have the same reference numerals.

FIG. 2 shows a faucet that comprises a base 10 for permanent mounting on a section 60 of a hydraulic device by means of fastening devices, such as screws 61 and nuts 62 for example, and a body 20 for detachable mounting on the base 10. This type of faucet is normally used particularly for controlling the water flow in a washbasin, sink, or bidet, or for similar uses.

The base 10 has connections 11, to which the supply pipes 63 and optionally discharge pipe can be connected. In this case as well, the body 20 has the shape of a bell, or as the case may be a pot, with a larger opening 8 on the side facing the base 10, and the body comprises the totality of the mechanisms 40-43. The mechanisms are accessible via the larger opening 8 in the body 20, can be inserted into the body 20 via the opening and removed from it when the body is detached from the base 10.

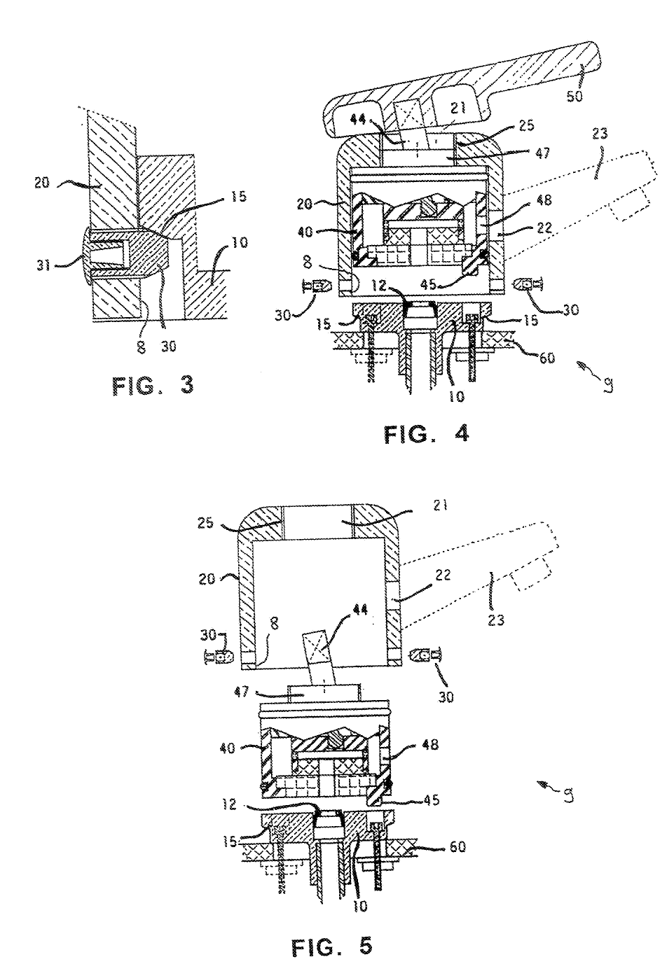

In the embodiment shown in FIG. 2, the body 20 is fixed to the base 10 by means of a pair of set-screws 30, which are screwed from the side into the lateral wall of the body 20 close to the larger opening 8 in the body 20, the screws engaging with an annular surface 15 in the shape of a truncated cone provided around the circumference of the base 10. In this manner, the body 20 is axially secured on the base 10. This arrangement is shown in detail in FIG. 3. Plugs 31 can cover, conceal or protect the set-screws 30.

In the embodiment shown in FIG. 2, the body 20 has a lateral opening 22 in order to supply an outlet 23, but it is obvious that, in other embodiments, the water can be discharged via pipes in the base 10.

In this embodiment as well, the mechanisms provided in the body 20 form a cartridge 40, which comprises a fixed base disk 41, a moveable control disk 42, a slide 43 for actuating the moveable control disk 42, and a control lever 44. The latter protrudes from a small opening 21 that is provided in the body 20 on the side 7 of the body opposite the larger opening. An adjusting lever 50, which can be actuated by the user, is affixed to the control lever 44. The cartridge 40, in this embodiment, has one or more peripheral holes 48, which discharge into a peripheral duct that is at least partially ring-shaped, through which duct the lateral opening 22 of the body 20 is supplied.

In this case as well, it is sufficient to unscrew the screws 30 in order to detach the body 20 from the base 10. Then, with the adjusting lever 50 removed, the cartridge 40 can be removed from the body 20 through the larger opening 8, which is provided on the side of the body 20 that in the installation position is connected to the base 10.

In the embodiment shown in FIG. 2 as well, hydraulic tightness between the connections 11 of the base 10 and the mechanisms 40-43 inside the body 20 is provided by means of frontal or face sealing means (axial sealing means), which also in this example are made of elastic sleeves 12, which are inserted into corresponding seats (without reference numerals in FIG. 2), which are provided in the form of cascaded recesses in the base 10.

The correct orientation of the entirety of the mechanisms 40-43 of the faucet 9 relative to the base 10 is secured by positioning means, such as a projection 45 on the cartridge 40, which engages a recess in the base 10 that forms a seat, or vice versa. A fastening device (screws 30 and surface 15), provided in this case between the base 10 and the body 20, does not, however, determine the angle at which the body 20 is positioned. If this angle orientation is to be fixed, the mechanisms 40-43, for example the housing of the cartridge 40, may be provided with positioning means inside the faucet 9 in the form of a projection 46 to engage a corresponding seat 24 that is recessed into the body 20. If the option of selecting different orientations for the body 20 is desired, a corresponding number of recessed seats 24 for the projection 46 of the inner mechanisms 40-43 can be provided in the body. However, it is also possible to have no positioning means for the relative position of the body 20 relative to the base 10, or as the case may be, in relation to the mechanisms 40-43.

In a variant of the arrangement described above, as shown in FIGS. 4 and 5, the cartridge 40 may comprise a flange 47, which is jagged or non-circular in some other way, prismatic for example, and which engages the opening 21, which has a complementary configuration, or as the case may be a limiting wall 25. In this way, the flange 47 and the limiting wall 24 interact in such a way that the potential relative position(s) of the body 20 relative to the cartridge 40 (and therefore also relative to the base 10) is (are) defined.

FIGS. 4 and 5 illustrate in detail how the faucet 9 can be demounted: Based on the mounted configuration in FIG. 2, it is sufficient to unscrew the set-screws 30, so that they are free of, or as the case may be, detached from the truncated-cone shaped surface 15 of the base 10, in order to detach the body 20 with all the mechanisms 40-43, which is comprises, from the base 10 (cf. FIG. 4).

It is now sufficient to detach the adjusting lever 50 from the control lever 44 of the internal mechanisms 40-43, in order to remove the latter via the larger opening 8 in the body 20 (cf. FIG. 5). This is an extremely simple operation, particularly when the internal mechanisms 40-43 comprise a cartridge 40, as in the embodiments shown.

It can be seen that in the case of this faucet 9, the internal mechanisms 40-43 of the faucet 9 can be removed easily and quickly, that the hydraulic coupling between the fixed base 10 and the body 20 of the faucet 9 is noncritical, that the structure of the body 20 of the faucet 9 is simplified and has reduced dimensions, and that design freedom is possible regarding the body 20, whereby all of these things are achieved with simple means and structures, and by simple and cost-efficient processes.

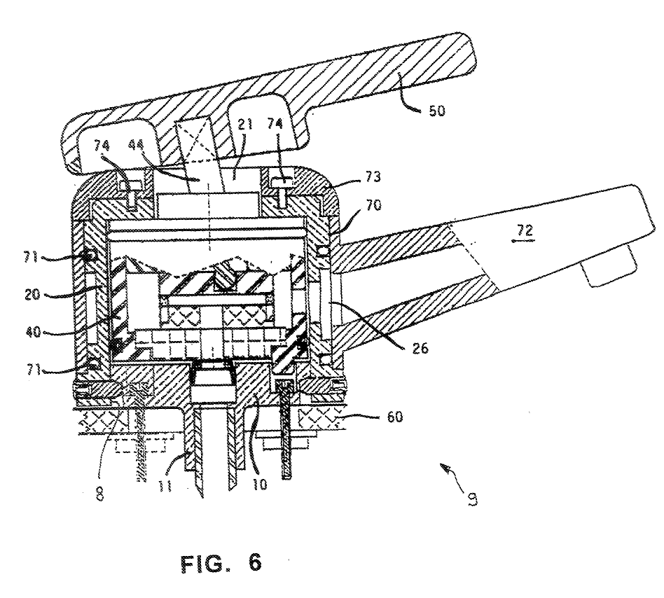

In the embodiment shown in FIG. 6, the body 20, in the form of a bell or pot, forms a support, or as the case may be a load-carrying portion for an external cylindrical and at least partially tubular structure 70, which is rotatably mounted on the body 20 by interposing protective gaskets 71, for example O-rings. The body 70 comprises an outlet 72, which can therefore be aligned in relation to the body 20. This external body 70, which is rotatable relative to the body 20, is held in place by a ring 73 that serves as a cap, the ring being affixed to the body 20 by means of screws 74 or any other fasteners. An annular duct 26, which is preferably formed in the outer wall of the body 20 and extends in the circumferential direction, guarantees supply to the outlet 72, independently of its position relative to the body 20.

In this embodiment, the external rotateable body 70 can be demounted together with the outlet 72, so that only the adjusting lever 50 and the ring 73 are demounted, without it being necessary to detach the body 20 from the base 10. On the other hand, the cartridge 40 can be replaced by detaching the body 20 from the base 10, without requiring demount of the external rotatable body 70 from the body 20.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. The faucet (9) with a base (10) for permanent installation and a body (20), which can be detachably attached to the fixed base (10), the detachable body (20) having a substantially bell or pot-shaped form, with a larger opening (8) on the side intended for connection with the fixed base (10), and with a smaller opening (21) on the opposite side (7), characterized in that the mechanisms (40-43) that are necessary for the functions of controlling the temperature and amount of water are present in the inside of the faucet (9), can be inserted via the larger opening (8) in the detachable body (20) and removed from the body (20) via the larger opening (8), and that the detachable body (20), together with the mechanisms (40-43) inserted into it, can be attached to the fixed base (10) and are detachable from it.

2. The faucet (9) according to claim 1, characterized in that the bell or pot-shaped body (20) is a single piece.

3. The faucet according to claim 1, characterized in that the bell or pot-shaped body comprises a plurality of parts, with a tubular part and a partial end-closing ring that is connected thereto.

4. The faucet (9) according to claim 1, characterized in that the mechanisms (40-43) on the inside of the faucet (9) comprise a cartridge (40), which can be inserted as a whole via the larger opening (8) into the bell or pot-shaped body (20) or removed therefrom.

5. The faucet (9) according to claim 1, characterized in that the base (10) of the faucet (9) is made of metal and comprises connections (11) for tubes, and that the bell or pot-shaped body (20) of the faucet (9) is fabricated of injection-molded plastic material or a machined metal.

6. The faucet (9) according to claim 1, characterized in that the totality of the mechanisms (40-43) inside the faucet (9) comprise positioning means (45) relative to the base (10).

7. The faucet (9) according to claim 1, characterized in that the totality of the mechanisms (40-43) comprises positioning means (46) relative to the body (20).

8. The faucet (9) according to claim 7, characterized in that the positioning means (46) relative to the body (20) have a plurality of selective, discrete operating positions.

9. The faucet (9) according to claim 6, characterized in that the positioning means comprise a projection (45, 46) on one component (40-43), and at least one corresponding seat (14, 24) recessed into the other component (10, 20).

10. The faucet (9) according to claim 7, characterized in that the positioning means provided between the body (20) of the faucet (9) and the mechanisms (40-43) comprise non-circular, preferably serrated or prismatic means (47) for reciprocal coupling.

11. The faucet (9) according to claim 1, characterized in that the hydraulic tightness between the fixed base (10) and the totality of the mechanisms (40-43) is produced inside the body (20) by means of a frontal or face effective sealing means (12).

12. The faucet (9) according to claim 11, characterized in that the frontal, or as the case may be face effective sealing means comprises a sleeve (12), which is placed in a hollow seat (13), which is present in the base (10) or in the mechanisms of the faucet (9).

13. The faucet (9) according to claim 11, characterized in that the totality of the mechanisms (40-43) comprises a base disk (41), which interacts directly with the sealing means (12) that is frontally, or as the case may be face effective between the base (10) and the mechanisms (40-43).

14. The faucet according to claim 11, characterized in that the totality of the mechanisms comprises a fixed closing plate, which interacts directly with the sealing means that is frontally, or as the case may be face effective between the base and the mechanisms.

15. The faucet (9) according to claim 1, characterized in that the bell or pot-shaped body (20) is affixed to the fixed base (10) by means of at least two screws (30) that extend through the body (20) in the longitudinal direction thereof.

16. The faucet (9) according to claim 1, characterized in that the fixed base (10) comprises a ring-shaped part with a truncated-cone shaped surface (15), as well as at least two set-screws (30) screwed into a wall of the detachable body (20), which, in the operating position, act against the truncated-cone shaped surface (15) of the base (10) in order to anchor the bell or pot-shaped body (20).

17. The faucet (9) according to claim 1, characterized in that a cylindrical and/or tubular body (70) is rotatably mounted on the bell or pot-shaped body (20) and holds an outlet (72) in place.

18. The faucet according to claim 17, characterized in that the cylindrical and/or tubular body (70) is held in place by a ring (73) affixed to the body (20), said ring serving as a cap.
